(19) United States
(12) Patent Application Publication
(10) Pub. No.: US 2006/0190144 A1
(43) Pub. Date: Aug. 24, 2006

(54) On-vehicle device control system

(75) Inventor: Akihiro Ogasawara, Toyokawa-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/407,215

(22) Filed: Apr. 20, 2006

Related U.S. Application Data
(62) Division of application No. 10/682,887, filed on Oct. 14, 2003, now abandoned.

(30) Foreign Application Priority Data
Dec. 19, 2002 (JP) 2002-368906

(51) Int. Cl. G05D 1/00

(52) U.S. Cl. 701/1

(57) ABSTRACT

A navigation apparatus is connected through a LAN to a master ECU which outputs a vehicle ID signal including type information showing a type of a vehicle, and obtains the type information from the master ECU. The navigation apparatus stores a map describing specifications such as functions assigned to the steering switches which are sorted by the vehicle type, and sets an operating condition according to the specification corresponding to the obtained type information. For this reason, the navigation apparatus does not need modifying in mounting on the vehicles of plural types.

### CROSS REFERENCE TO RELATED APPLICATION

This application is related to and incorporates herein by reference Japanese Patent Application No. 2002-368906 filed on Dec. 19, 2002.

### FIELD OF THE INVENTION

This invention relates to an on-vehicle device control system capable of changing an operating condition of an on-vehicle device in accordance with a type of a vehicle on which the on-vehicle device is mounted.

### BACKGROUND OF THE INVENTION

For example, Japanese Patent Publication No. 2001-306330 discloses a display apparatus for a vehicle capable of changing operation switches displayed as touch switches on a screen depending on types of vehicles.

The display apparatus comprises, as shown in FIG. 4, a main controller 6 for controlling an image-drawing process on a LCD panel 3 which is a display, and a switch controller 7 for controlling input/output processes of operation signals from touch switches 4 displayed on the LCD panel 3 and switches of an operation panel 5 provided around the LCD panel 3. The main controller 6 stores a control program including a common program common to all types of the vehicles on which the display apparatus might be mounted, and plural inherent programs inherent to each type of the vehicles. The switch controller 7 stores a vehicle type code showing a type of the vehicle on which the display apparatus should be mounted, in addition to a program for the input/output processes of the operation signals.

When, for example, an air conditioner switch is operated, the main controller 6 obtains the vehicle type code from the switch controller 7 and displays an image including operation switches for an air conditioner, corresponding to the vehicle type code. That is, the main controller 6 makes effective the inherent program corresponding to the vehicle type code obtained from the switch controlling part 7 among the plural inherent programs.

According to the conventional display apparatus 1, the control program in the main controller 6 can be commonly used, irrespective of the type of the vehicle on which the display apparatus is mounted.

The operation panel 5 of the conventional display apparatus 1, however, is changed depending on the types of the vehicles. Therefore, in the switch controller 7, as the program for carrying out the input/output processes of the operation signals from the operation panel 5, plural programs exclusive to each type of the vehicles need to be prepared. In addition, because the conventional display apparatus 1 adopts a constitution in which the switch controller 7 stores the vehicle type code showing the type of the vehicle, even if the identical operation panel 5 and the identical program for the input/output processes are commonly used for every type of the vehicles, the switch controller 7 must be changed in accordance with the vehicle type to store the vehicle type code.

### SUMMARY OF THE INVENTION

An object of the present invention is, therefore, to provide an on-vehicle device control system which can be universally commonly used, irrespective of a type of a vehicle on which the on-vehicle device such as a vehicle display device is mounted.

According to a first aspect of the present invention, an on-vehicle device control system comprises output means for storing at least type information showing a type of a vehicle and outputting the type information at a predetermined timing, an on-vehicle device which stores plural specifications to be set in each type of vehicles, and network means connected to the output means for transmitting the type information outputted from the output means to another on-vehicle device. The on-vehicle device extracts the specification corresponding to the type information at a time of obtaining the type information outputted from the output means, and sets an operating condition according to the specification.

As described above, the on-vehicle device control system according to the first aspect of the invention is constituted such that the network means connects the output means for storing the type information showing the type of the vehicle and the on-vehicle device, and the on-vehicle device obtains the type information from the output means through the network means. Therefore, the on-vehicle device can set the operation condition according to the specification in correspondence with the vehicle type based on the type information from the output means. In this way, while the on-vehicle device control system enables the on-vehicle device to set the operating condition corresponding to the vehicle type, the on-vehicle device need not to be modified in any way as for both hardware and software and can be commonly used to each type of the vehicles. As a result, it is possible to remarkably reduce the cost necessary for developing and manufacturing the on-vehicle device

According to a second aspect of the present invention, the on-vehicle device in the on-vehicle device control system comprises operating means including a plurality of switches for instructing to carry out functions having been assigned thereto. The on-vehicle device stores functions to be assigned to the plurality of switches as the specifications to be set in each type of the vehicles, extracts the functions to be carried out in the vehicle of the type corresponding to the type information, and assigns the extracted functions to the plurality of switches. The plurality of switches may be installed in the vicinity of the on-vehicle device. Alternatively, the plurality of switches may be mechanical switches installed in a steering wheel or touch panel type switches formed integrally with a display device, which are displayed on a screen of the display device. By changing the functions assigned to the switches installed in the vicinity of the on-vehicle device or in the steering wheel depending on the type information, there is no need to prepare the operation panels and switch controllers exclusive to each type of the vehicle like the conventional display apparatus.

It is preferable that the output means outputs the type information every time the vehicle starts. As a result, the on-vehicle device can start its operation with the operating condition corresponding to the vehicle type as soon as the vehicle can start.

The on-vehicle device may set the operating condition according to a predetermined default data, if it can not obtain the type information from the output means when the vehicle starts. Due to this, even if the on-vehicle device can not obtain the type information because of any trouble occurring in the network means and so on, it is possible for the on-vehicle device to set the operating condition without the type information from the output means.

The on-vehicle device may store the operating condition having been set, and starts its operation with the stored operating condition when the type information can not be obtained from the output means at the time of the vehicle starting. In this way, even if the on-vehicle device can not obtain the type information because of any trouble, the on-vehicle device can start its operation with the same operating condition as one set when the type information is normally obtained.

The on-vehicle device may halt its operation if the type information outputted from the output means does not correspond to any type of the vehicles stored in the on-vehicle device. This is because, when the on-vehicle device is mounted on the vehicle which it should not be mounted on, it is conceivable that an injustice such as a theft is committed. It is to be noted that, when the output means outputs unique information such as a manufacturing number of a vehicle along with the type information, the on-vehicle device may store the unique information and halt its operation if a newly obtained unique information is different from the stored unique information.

### BRIEF DESCRIPTION OF THE DRAWINGS

The other objects and features of the present invention will become more readily apparent from the following detailed description taken in conjunction with the accompanying drawings in which:

FIG. 1 is a block diagram illustrating a whole constitution of an on-vehicle device control system according to an embodiment of the present invention;

FIG. 2 is a flowchart illustrating a process for carrying out the setting of steering switches, the setting of an initial screen image in a display device and so on;

FIG. 3 is a map illustrating functions to be assigned to six steering switches SW1 to SW6, the initial screen image to be selected, and colors of operating switches to be displayed on the display device, depending on vehicle type codes;

FIG. 4 is a block diagram illustrating a constitution of the conventional vehicle display apparatus.

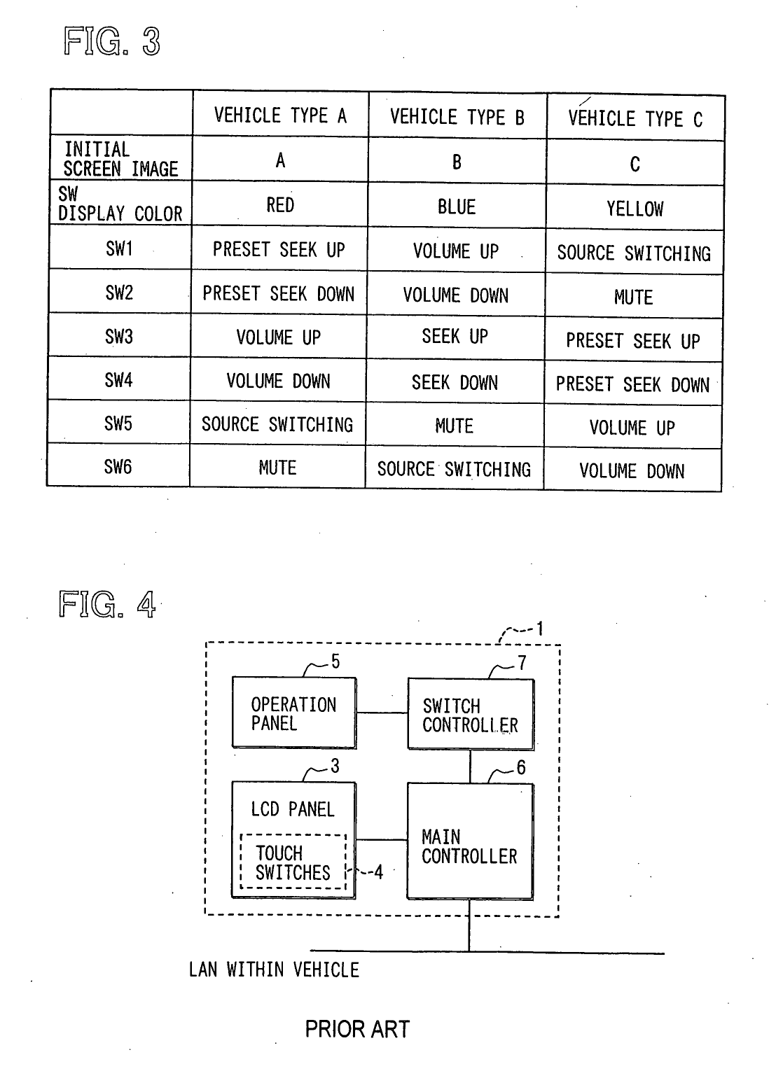

### DETAILED DESCRIPTION OF THE PREFERRED EMBODIMENT

An on-vehicle device control system according to an embodiment of the present invention will be described with reference to the drawings. In this embodiment, an on-vehicle device is a navigation apparatus having an audio controller.

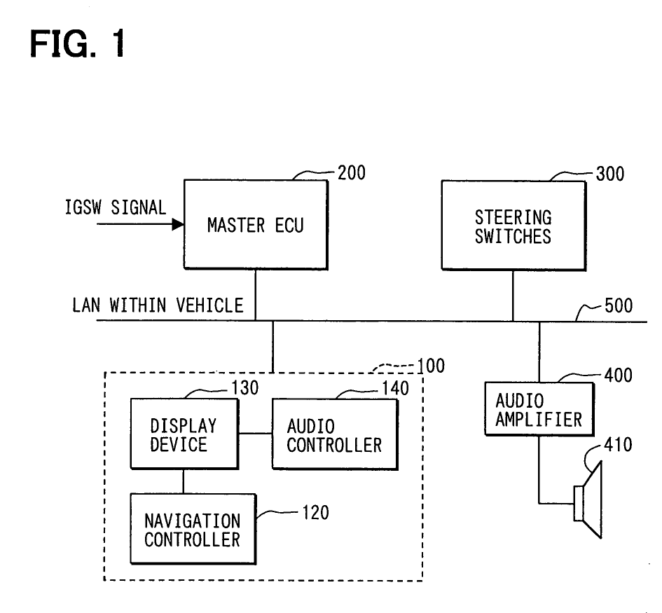

FIG. 1 is a block diagram illustrating a whole constitution of the on-vehicle device control system according to the embodiment of the present invention. As shown in FIG. 1, the navigation apparatus 100 has a navigation controller 120, a display device 130, and an audio controller 140. The navigation apparatus 100 is connected to a master ECU 200, steering switches 300, an audio amplifier 400 and so on, through a local area network (LAN) 500 within the vehicle.

The navigation controller 120, though not shown in the figure, comprises a position detector for detecting a current position of the vehicle, a map data storing device for storing map data and so on. The navigation controller 120 displays a peripheral map along with a vehicle mark showing the current position of the vehicle on the display device 130, on a basis of current position data from the position detector and map data from the map data storing device. Also, when a destination is set, the navigation controller 120 carries out route guidance by indicating a route to the destination on the map.

The display device 130 is a liquid crystal display for example. The display device 130 contains a detector (not shown) for detecting contacts in display areas of operation switches when displayed on the screen. As known well, the detector is formed by a plurality of light emitting and receiving devices provided around the screen or a pressure-sensitive film, for example. In this way, the display device 130 is of a touch panel type and is used for various input operations.

The audio controller 140, though not shown in the figure, has various kinds of audio devices such as a compact disc (CD) player, a television tuner, and a radio tuner. The audio controller 140 has an ordinary computer provided with a CPU (central processing unit), a ROM (read only memory), a RAM (random access memory), an Input-Output Circuit, and a bus line connecting therebetween, all of which are well known. Written in the ROM is a program carried out by the audio controller 140, and the audio controller 140, for example, displays operation switches of the audio devices on the display device 130, and outputs audio and visual signals from the audio devices to the audio amplifier 400 and the display device 130, according to that program.

In addition, the ROM of the audio controller 140 stores a program for obtaining a vehicle identification (ID) signal including a vehicle type information from the master ECU 200 which will be described later and for carrying out the setting of the steering switches and so on, in accordance with the vehicle type information, and a map showing a correspondence relationship between the functions assigned to the steering switches and so on, and the type information.

The master ECU 200 controls operations of the on-vehicle devices. The master ECU 200 obtains a signal from an ignition switch (IGSW), and when it detects based on the IGSW signal that either an accessory switch or ignition switch is turned on, it outputs a starting signal to the on-vehicle devices through the LAN 500. After the starting signal is outputted, the master ECU 200 outputs the vehicle ID signal including a vehicle-manufacturing company, a type of a vehicle, a vehicle manufacturing number and so on, to the on-vehicle devices.

The steering switches 300 are installed in a hub portion of a steering wheel not shown in the figure. In this embodiment, six steering switches SW1 to SW6 are formed as ordinary push switches, for example.

The audio amplifier 400 amplifies the audio signal from the audio controller 140 as described above and outputs it to a speaker 410.

Next, the processing for carrying out the setting of the steering switches 300, the setting of an initial screen image displayed in the display device 130 and so on, in accordance with the type information will be described in detail.

When, for example, the navigation apparatus 100 starts up, there is a case where a predetermined initial screen image is displayed on the screen until the preparation for displaying a map is made. In the initial screen image, it is preferable to display a name of the company which manufactured the vehicle, a model name of the vehicle or the like

Also, in consideration of making the operation of the audio device easier, there is a case where the operation switches for the audio device are installed in the steering wheel. In this case, it is normal that the functions performed by those switches are different from each type of the vehicles.

In the on-vehicle device control system according to the embodiment, while satisfying a request of customization for each type of the vehicles, the identical on-vehicle device can be commonly used in plural types of the vehicles by the process described below.

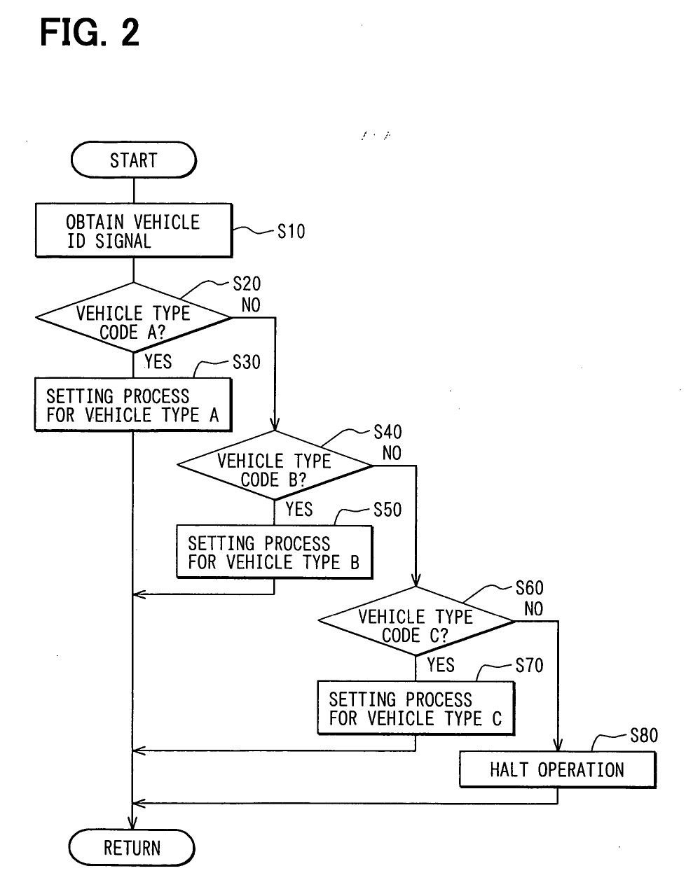

FIG. 2 is a flowchart illustrating a process for carrying out the setting of the steering switches 300, the setting of an initial screen image in the display device 130 and so on, to set the operating condition of the navigation apparatus 100. The process shown by the flowchart in FIG. 2 is performed by the audio controller 140 in the on-vehicle control system.

In a step S10, the audio controller 140 obtains the vehicle ID signal outputted from the master ECU 200. As described above, this vehicle ID signal is outputted from the master ECU 200, immediately after the starting signal is outputted.

In a step S20, it is determined whether or not the type information included in the vehicle ID signal corresponds to a vehicle type code A. When it is determined at the step S20 that the type information corresponds to the vehicle type code A, a setting process for a vehicle type A is performed at a step S30. Conversely, when it is determined at the step S20 that the type information does not correspond to the vehicle type code A, it is further determined at a step S40 whether or not the type information corresponds to a vehicle type code B. When it is determined that the type information corresponds to the vehicle type code B, a setting process for a vehicle type B is performed at a step S50. In the same manner, it is determined at a step S60 whether or not the type information corresponds to a vehicle type code C. When determined that the type information corresponds to the vehicle type code C, a setting process for a vehicle type C is performed at a step S70.

It is to be noted that, when it is determined by the steps S20, S40 and S60 that the type information does not corresponds to any one of the vehicle type codes A, B and C, the navigation apparatus 100 as the on-vehicle device halts its operation. The navigation apparatus should be mounted on any vehicle among the vehicle types A, B and C. In this case, if it is determined by the steps S20, S40, S60 that the navigation apparatus 100 has been mounted on a vehicle of a type other than the vehicle types A, B and C, because it is conceivable that an injustice such as a theft is committed, the navigation apparatus 100 halts its operation.

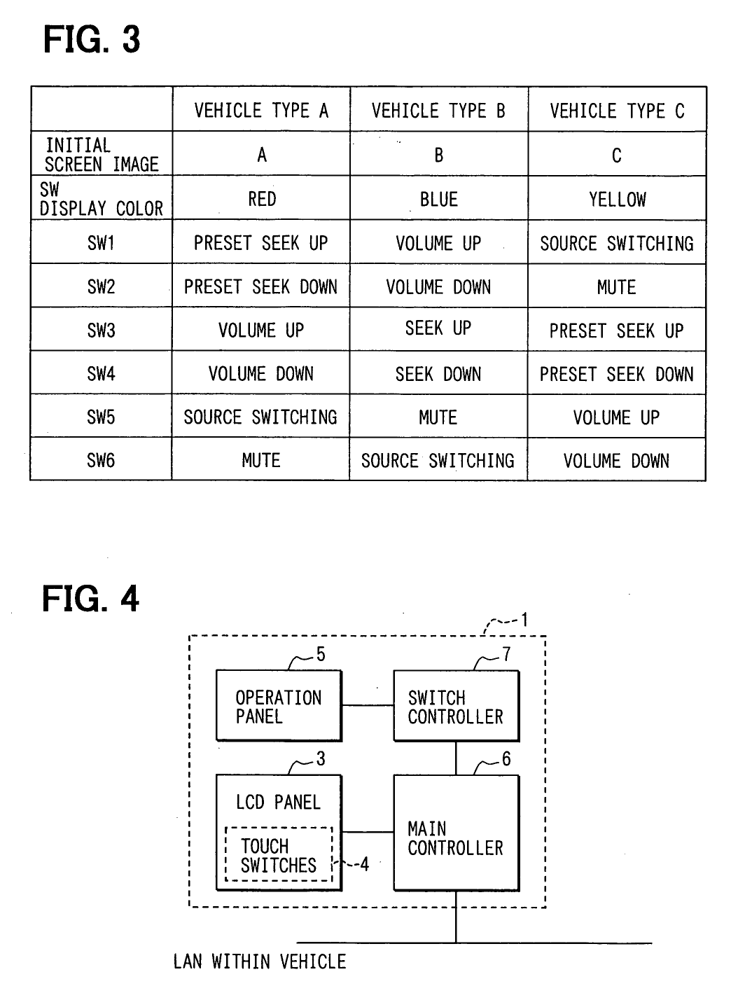

As a result of the process shown by the flowchart in FIG. 2, when the type information included in the vehicle ID signal corresponds to any vehicle type code, the setting process by which an operating condition of the navigation apparatus 100 is set according to the specification corresponding to the vehicle type code. This setting process will be described in reference with a map illustrated in FIG. 3.

FIG. 3 is a map illustrating each of specifications in accordance with the vehicle type codes, that is, functions to be assigned to six steering switches SW1 to SW6, the initial screen images to be selected, and colors of operating switches to be displayed on the display device, depending on vehicle type codes.

As illustrated in this map, when it is determined that the vehicle is of the vehicle type A represented by the vehicle type code A, the initial screen image A in which a name of a company manufacturing the vehicle of the type A and a model name thereof are displayed is selected. Further, as a display color for the operation switches displayed in the display device 130, a red color similar to a background color of the initial screen image A is selected. As for the six steering switches SW1 to SW6, a preset seek up function is assigned to the steering switch SW1. This preset seek up function is for increasing a frequency of a currently selected radio station up to a frequency of a radio station pre-selected and stored by an initial setting. A preset seek down function is assigned to the steering switch SW2. The preset seek down function is opposite to the preset seek up function and decreases the frequency of the currently selected radio station to the frequency of the radio station stored in advance. A volume up function is assigned to the steering switch SW3, and a volume down function is assigned to the steering switch SW4. Therefore, the volume of the audio device can be adjusted by those steering switches SW3, SW4. A source switching function is assigned to the steering switch SW5. By this steering switch sw5, the audio device brought in operation is switched in a predetermined order. A mute function is assigned to the steering switch SW6. By this steering switch sw6, the audio sound of the audio device can be temporarily muted.

When the operating condition of the navigation apparatus 100 is set according to the specification corresponding to either the vehicle type B or the vehicle type C based on the type information included in the vehicle ID signal, by referring to the map of FIG. 3 as well as the case of the vehicle type A, the initial screen image of the navigation apparatus 100 and the display color of the operation switches are respectively selected, and predetermined functions are respectively assigned to steering switches SW1 to SW6.

It is to be noted that the functions assigned to the steering switches SW1 to SW6 are note limited to the examples described above, and all of the functions for operating the audio device are applicable.

As described above, the on-vehicle device control system according to the embodiment stores the map describing functions assigned to the steering switches and so on which are sorted by the vehicle type, and obtains the type information through the LAN 500. For this reason, while the operating condition of the on-vehicle device (navigation apparatus) can be changed in accordance with the vehicle type, the navigation apparatus does not at all need modifying in mounting on the vehicles of plural types, and therefore the navigation apparatus can be completely commonly used to the vehicles of plural types.

The present invention is not limited to the above-described embodiment and can be changed therefrom in many ways.

For example, although the functions assigned to the steering switches SW1 to SW6 are changed in accordance with the vehicle type, the operation switches displayed in the display device 130 may be changed in accordance with the vehicle type as well. The functions of the on-vehicle device assigned to the switches may also be changed depending on the vehicle type. In addition, the above-described embodiment described the example in which the present invention is applied to the navigation apparatus containing the audio controller. However, the on-vehicle device is not limited to the navigation apparatus. As long as it is a control device mounted on a vehicle, it becomes an object that the present invention is applied to.

In the above-described embodiment, explanation was given on the assumption that the master ECU 200 outputs the vehicle ID signal and the navigation apparatus 100 normally obtains the vehicle ID signal. However, it is conceivable that the navigation apparatus 100 can not obtain the vehicle ID signal if any trouble occurs in the LAN 500, the master ECU 200 or the like. For this reason, the navigation apparatus 100 may set default data as for the initial screen image, the display color of the operation switches, and the functions assigned to the steering switches. When the vehicle ID signal can not be obtained, the navigation apparatus may set the operating condition according to the default data.

Alternatively, when the vehicle ID signal can be obtained and the operating condition is set in accordance with the vehicle type, the navigation apparatus may store the operating condition. If the vehicle ID signal can not be obtained at the time of the vehicle starting, the navigation apparatus may start its operation with the stored operating condition. In this way, the navigation apparatus 100 can start its operation with the same operating condition as one set when the type information is normally obtained.

Further, in the above-described embodiment, the navigation apparatus 100 halted its operation if the type information included in the vehicle ID signal does not corresponds to any type of the vehicles on which the navigation apparatus 100 should be mounted. However, if the master ECU 200 outputs the vehicle ID signal including unique information of the vehicle such as a vehicle manufacturing number like the above-described embodiment, the navigation apparatus may store the unique information at the time of obtaining the vehicle ID signal. And, the navigation apparatus 100 may halt its operation if a newly obtained unique information is different from the stored unique information.

1-8. (canceled)

9. A navigation apparatus comprising:
obtaining means for obtaining a vehicle type information through a local area network provided within a vehicle from a separate device;
storing means for storing plural specifications to be set in each type of vehicle; and
setting means for setting an operating condition according to the specification corresponding to the vehicle type information obtained by said obtaining means.

10. The navigation apparatus according to claim 9 further comprising a display device for displaying a peripheral map along with a vehicle mark representing a current position of the vehicle, wherein said setting means sets an initial screen image of said display device as said operating condition.

11. The navigation apparatus according to claim 9, further comprising a plurality of switches for instructing functions assigned thereto to be carried out, wherein said storing means stores functions to be assigned to the plurality of switches as the specifications to be set in each type of the vehicles, and said setting means extracts the functions to be carried out in the vehicle of the type corresponding to the vehicle type information and assigns the extracted functions to the plurality of switches.

12. The navigation apparatus according to claim 11, wherein the plurality of switches is installed in a steering wheel.

13. The navigation apparatus according to claim 9, wherein said obtaining means obtains the vehicle type information every time the vehicle starts.

14. The navigation apparatus according to claim 13, wherein said setting means sets the operating condition according to a predetermined default data, if said obtaining means can not obtain the vehicle type information from said separate device when the vehicle starts.

15. The navigation apparatus according to claim 13, wherein said storing means stores the operating condition having been set, and the stored operating condition is set if the vehicle type information can not be obtained from said separate device when the vehicle starts.

16. The navigation apparatus according to claim 9, wherein said navigation apparatus halts its operation if the type information obtained by said obtaining means does not correspond to any type of the vehicles stored in said storing means.

17. The navigation apparatus according to claim 9, wherein said obtaining means obtains unique information of the vehicle along with the vehicle type information, and said navigation apparatus stores the unique information and halts its operation if a newly obtained unique information is different from the stored unique information.
